(19) United States
(12) Patent Application Publication
(10) Pub. No.: US 2011/0210270 A1
(43) Pub. Date: Sep. 1, 2011

(54) OPTICAL TOMOGRAPHY MEASUREMENT DEVICE

(75) Inventor: Yu TOJO, Ashigarakami-gun (JP)

(73) Assignee: FUJIFILM Corporation, Tokyo (JP)

(21) Appl. No.: 12/979,195

(22) Filed: Dec. 27, 2010

(30) Foreign Application Priority Data
Feb. 26, 2010 (JP) 2010-042994

(51) Int. Cl. G01J 1/58

(52) U.S. Cl. 250/458.1

(57) ABSTRACT

An optical tomography measurement device that includes an illumination component, a light reception component, a change component, an acquisition component and a correction component is provided. The acquisition component acquires reference data corresponding to an amount of fluorescent light received by the light reception component when an excitation light is illuminated onto the reference position, first data corresponding to the amount of fluorescent light received by the light reception component when the excitation light is illuminated onto a first illumination position, and second data corresponding to the amount of fluorescent light received by the light reception component when the excitation light is illuminated on a second illumination position. The correction component corrects the reference data so as to remove fluorescent light components emitted from a fluorescent marking agent outside of a measurement plane based on the first data and the second data.

### CROSS-REFERENCE TO RELATED APPLICATION

This application claims priority under 35 USC 119 from Japanese Patent Application No. 2010-042994 filed on Feb. 26, 2010, the disclosure of which is incorporated by reference herein.

### BACKGROUND OF THE INVENTION

1. Field of the Invention

The present invention relates to an optical tomography measurement device applied in optical tomography and employed to reconstruct section images of a living organism as a measurement subject.

2. Description of the Related Art

Body tissue has transmissivity to light of specific wavelengths, such as, for example, near infrared radiation. Based on this, Japanese Patent Application Laid-Open (JP-A) Nos. 11-173976 and 11-33 7476 propose performing observations inside living organisms by employing light (optical CT).

In such optical CT, since multiple-scattering occurs when light is being transmitted through the measurement subject, JP-A No. 5-261107 has noticed that there is a difference between the actual light path length of light within a measurement subject and a straight line between the incident position and emission position to and from the measurement subject, and adopts a method in which time-resolved measurements are employed to obtain the actual light path length of light within the measurement subject and to perform quantification measurements thereon.

Since both transmission forward light and multi-scattered light, these having different attenuation characteristics from each other, are contained in detected light amounts, there is a proposal in JP-A No. 11-230897 to derive a transmissivity distribution of an investigation subject by correcting light reception data based on correction data derived expressing the relationship between the thickness of the investigation subject and the transmission light attenuation amount.

There is also a proposal in JP-A No. 2240545 to obtain an optical tomographic image with good resolution by removing the scattered components of transmission light and extracting only data for the required absorption components.

Fluorescent light investigation methods are becoming of interest in which a fluorescent marking is performed to lesion sites and tissue of interest in a body, and observations are made of the distribution of fluorescent marker as a surrogate of the lesion. In experimental fields such as pathology, there is a proposal for fluorescent optical tomography in which living organisms such as small animals are used as the measurement subject, and tomographic images of reconstructed density distributions of fluorescent marking agent are generated.

As a method for fluorescent optical tomography of a lesion site, for example, a fluorescent marking agent, in which fluorescence is added to a substance having a specific affinity to the lesion site, is administered to a living organism. In order to obtain the density distribution of the fluorescent marking agent within the living organism (referred to below as the fluorescent light density distribution) the excitation light is illuminated onto a single spot on the surface of the living organism, the excitation light propagates inside the living organism while being repeatedly scattered and absorbed, excites an internal fluorescent substance, and the fluorescent light generated thereby and emitted from the surface of the body is detected at multiple point around the periphery of the living organism. A relationship according to the distribution of the fluorescent marking agent within the living organism, the scattering characteristics of the light, and the absorption characteristics of the light can be built up between measurement data obtained by repeatedly performing measurements while changing the illumination position of the excitation light. This relationship is then employed to reconstruct tomographic images expressing the density distribution of fluorescent light from the measurement data.

While such reconstruction of tomographic images is performable by computation in a 3-dimensional model, configuration for measurement in such cases is complicated and there is a high processing load. As a method to resolve this issue a method for reconstruction as a planar model (2-dimensional model) could be considered.

However, since light within the living organism scatters 3-dimensionally, a problem arises in that the reliability of reconstruction precision reduces due to cross-talk with fluorescent body distribution in adjacent cross-sections.

### SUMMARY OF THE INVENTION

In consideration of the above circumstances, an object of the present invention is to provide an optical tomography measurement device that can prevent or suppress a reduction in image reconstruction precision accompanying a reduction in the computation load.

In order to achieve the above object, an optical tomography measurement device of the present invention includes: an illumination component that illuminates excitation light onto a measurement subject from a light source disposed such that its optical axis is orthogonal to the body length direction of a living organism that is the measurement subject; a light reception component that is disposed such that its optical axis is in a measurement plane that is orthogonal to the body length direction of the measurement subject, and that receives fluorescent light generated from a fluorescent marking agent inside the measurement subject in response to the excitation light and emitted from a surface of the measurement subject; a change component that changes an illumination position of the excitation light onto the measurement subject by the illumination component to a reference position in the measurement plane and a first position and a second position disposed along the body length direction on either side of the reference position; an acquisition component that acquires reference data corresponding to the amount of fluorescent light received by the light reception component when the excitation light is illuminated onto the reference position, first data corresponding to the amount of fluorescent light received by the light reception component when the excitation light is illuminated onto the first illumination position, and second data corresponding to the amount of fluorescent light received by the light reception component when the excitation light is illuminated on the second illumination position; and a correction component that corrects the reference data so as to remove fluorescent light components emitted from the fluorescent marking agent outside of the measurement plane based on the first data and the second data.

According to this aspect of the present invention, the illumination component and the light reception component are disposed such that their optical axes are orthogonal to the body length direction of the living organism, the change component changes the illumination position by the illumination component to the reference position, and the first position and the second position disposed along the body length direction on either side of the reference position. The reference data corresponding to the amount of light obtained when the illumination position is the reference position is corrected based on the first data corresponding to the amount of light obtained when the illumination position is the first illumination position and the second data corresponding to the amount of light obtained when the illumination position is the second illumination position, so as to remove fluorescent light components generated from positions not in the measurement plane.

When this is being performed, since reference data is influenced by fluorescent light components generated by the fluorescent marking agent outside of the measurement plane, a reduction in image reconstruct precision can be prevented or suppressed by correcting the reference data based on the first data and second data for illumination positions positioned on either side of the measurement plane, respectively, so as to remove these extraneous fluorescent light components from the reference data.

Furthermore, the optical tomography measurement device of the present invention may be configured such that the change component changes the illumination position of the excitation light such that the first illumination position and the second illumination position are symmetrically disposed on either side of the measurement plane.

According to this aspect of the present invention, the change component changes the illumination position to the first illumination position and the second illumination position symmetrically disposed on either side of the measurement plane. The device configuration of the present invention can thereby be simplified further.

The optical tomography measurement device of the present invention may be configured such that: the illumination component includes a reference light source that illuminates the excitation light onto the reference position, a first light source that illuminates the excitation light onto the first illumination position, and a second light source that illuminates the excitation light onto the second illumination position; and the change component selectively operates the reference light source, the first light source or the second light source.

According to this aspect of the present invention, the illumination component has three light sources, the reference light source that illuminates the excitation light onto the reference position, the first light source that illuminates the excitation light onto the first illumination position, and the second light source that illuminates the excitation light onto the second illumination position. Consequently illumination position can be readily changed.

The optical tomography measurement device of the present invention may also be configured further including a movement component that moves the light source in the body length direction of the measurement subject, wherein the change component illuminates the excitation light onto the reference position, the first illumination position, or the second illumination position by moving the light source with the movement component.

According to this aspect of the present invention, the illumination position of the illumination component is changed to the reference position, the first position or the second position by the movement component moving the light source along the body length direction. Consequently, the illumination position can be switched over with a single light source.

The optical tomography measurement device of the present invention may also be configured further comprising a swing component that swings the optical axis of the excitation light generated from the light source, wherein the change component directs the optical axis of the excitation light to the reference position, the first illumination position, or the second illumination position using the swing component.

According to this aspect of the present invention, the illumination position is changed by the swing component swinging the optical axis of the excitation light to the reference position, the first illumination position, or the second illumination position.

The optical tomography measurement device of the present invention may also be configured further including a reconstruction component that, with the reference data corrected by the correction component as measurement data from the light reception component, reconstructs a fluorescent light density distribution within the measurement subject based on the measurement data.

According to this aspect of the present invention, a fluorescent light density distribution within the measurement subject is reconstructed with the reference data corrected by the correction component as the measurement data. Consequently reconstruction can be made of a fluorescent light density distribution from which fluorescent light components of fluorescent marking agent outside of the measurement plane have been removed.

The optical tomography measurement device of the present invention may also be configured further including a measurement position moving component that moves the measurement plane by moving the illumination component and the light reception component as one along the body length direction of the measurement subject.

According to this aspect of the present invention, the measurement position moving component moves the measurement plane on the measurement subject. Consequently reconstruction of a density distribution can be performed at a desired position on the measurement subject.

According to the present exemplary embodiment as explained above, an effect can be exhibited in which a reduction in image reconstruct precision accompanying a reduction in the processing load can be prevented or suppressed.

### BRIEF DESCRIPTION OF THE DRAWINGS

Exemplary embodiments of the present invention will be described in detail based on the following figures, wherein:

FIG. 1 is a schematic diagram showing relevant portions of an optical tomography measurement system according to a present exemplary embodiment;

FIG. 2 is a schematic perspective view showing an example of a mouse as measurement subject and a sample holder;

FIG. 3 is a schematic configuration diagram of relevant portions showing a mounted state to an optical measurement device of a sample holder in which a mouse is accommodated;

FIG. 4 is a perspective view showing a schematic configuration of relevant portions of an optical measurement device;

FIG. 5 is a schematic configuration diagram of relevant portions of an optical measurement device, as viewed along one direction orthogonal to the axial direction of a frame body;

FIG. 6 is a block diagram showing a control section of an optical tomography measurement system according to a first exemplary embodiment;

FIG. 7 is a diagram showing an example of a model of an anisotropic scattering medium;

FIG. 8 is a schematic configuration diagram showing relevant portions of a disposition of a measurement head section and sample holder according to the first exemplary embodiment;

FIG. 9A is a schematic diagram showing the illumination position of excitation light relative to a measurement plane, with the illumination position of excitation light shown on the measurement plane;

FIGS. 9B and 9C are schematic diagrams showing the illumination position of excitation light relative to a measurement plane, with the illumination position of excitation light shown at positions different from the measurement plane;

FIG. 10A is a schematic diagram showing an example of a phantom model applied for setting a correction coefficient k;

FIG. 10B is a graph showing measurement data obtained by computation based on the model of FIG. 10A;

FIG. 11 is a flow chart showing an example of acquisition of measurement data according to the first exemplary embodiment;

FIG. 12 is a flow chart schematically showing processing in a data processing device in which the measurement data is employed;

FIG. 13 is a schematic configuration diagram of relevant portions showing a disposition of a measurement head section and a sample holder according to a second exemplary embodiment;

FIG. 14 is block diagram showing a control section of an optical tomography measurement system according to the second exemplary embodiment;

FIG. 15 is a flow chart showing an example of acquisition of measurement data according to the second exemplary embodiment; and

FIG. 16 is a schematic configuration diagram of relevant portions showing an example of another disposition of a measurement head section and sample holder.

### DETAILED DESCRIPTION OF THE INVENTION

Explanation follows regarding exemplary embodiments of the present invention, with reference to the drawings.

### First Exemplary Embodiment

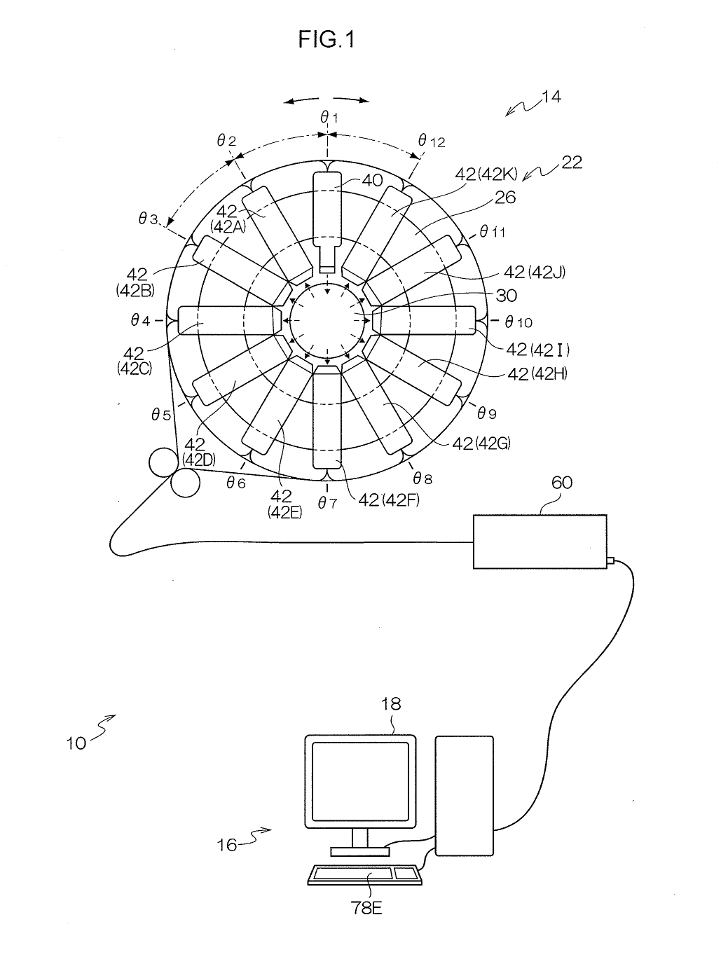

FIG. 1 to FIG. 6 show an schematic configuration of an optical tomography measurement system 10 according to a first exemplary embodiment. The optical tomography measurement system 10 is configured including an optical measurement device 14 according to the present invention, and a data processing device 16 for performing specific data processing on the measurement data obtained by the optical measurement device 14. Configuration of the optical tomography measurement system 10 may be made with the function of the optical measurement device 14 and the function of the data processing device 16 in an integrated configuration.

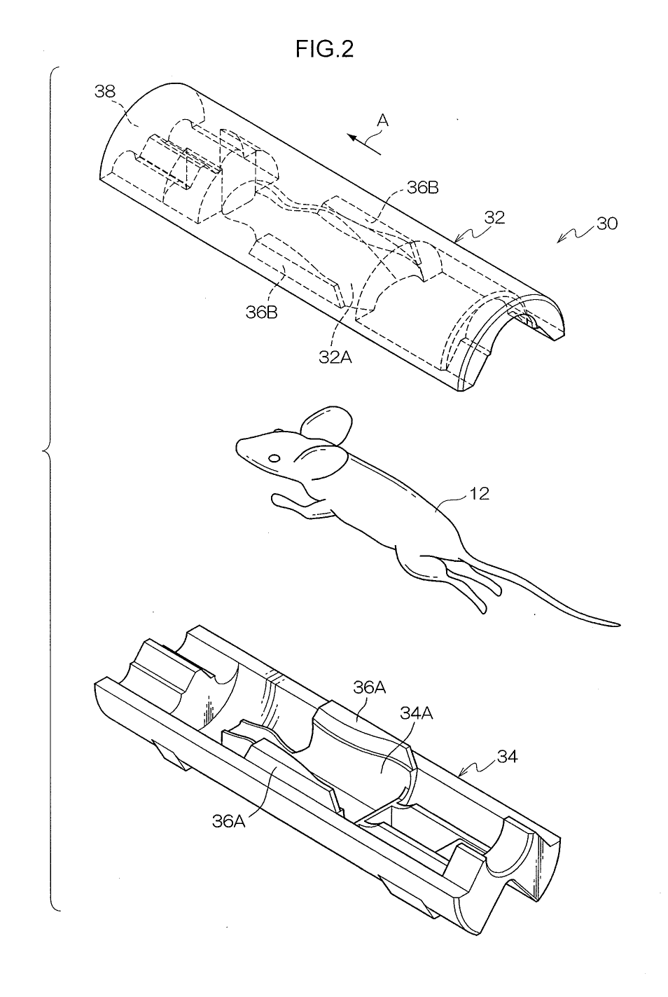

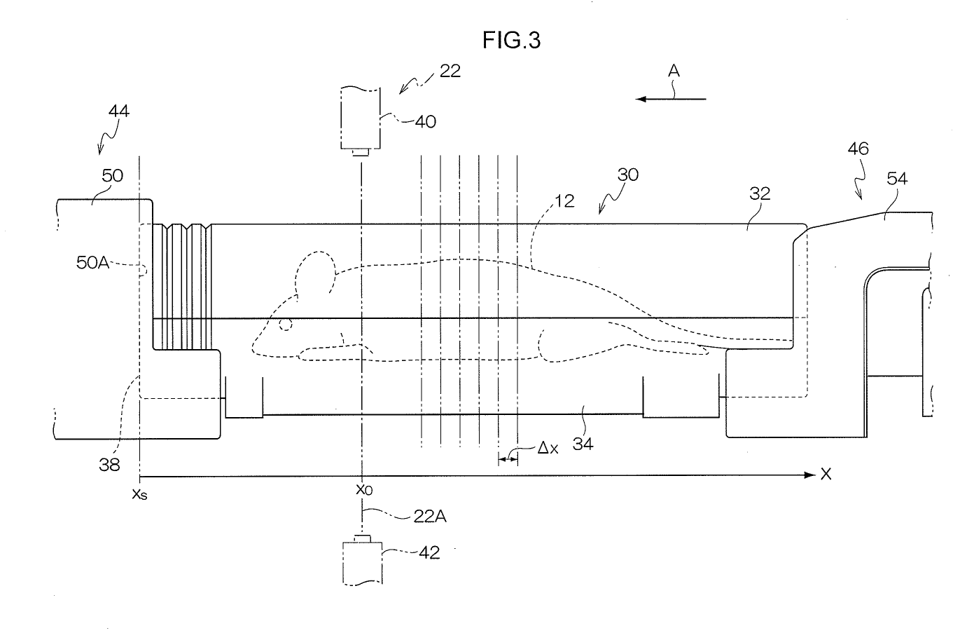

The optical tomography measurement system 10 has as the measurement subject, for example, a living organism, such as a small animal such as a nude mouse or the like. A fluorescent marking agent (fluorescent substance) is administered to the measurement subject and the optical tomography measurement system 10 reconstructs a tomographic image showing the density distribution within the body of the fluorescent marking agent. The reconstructed tomographic image is, for example, displayed on a monitor 18 or the like. Explanation follows of a case in which a mouse 12 is the measurement subject (see FIG. 2 and FIG. 3), however the optical measurement device 14 is not limited thereby, and any given living organism may be used as the measurement subject.

A lesion site, such as, for example, a tumor or the like, is induced (generated) in the mouse 12 that is the measurement subject by, for example, injecting in advance diseased cells, such as, for example, tumor cells. The fluorescent marking agent for administering to the mouse 12 is, for example, an antibody that specifically attaches to a specific site, such as a lesion site, to which a fluorescent substance has been applied. When the fluorescent marking agent is administered to the lesion-induced mouse 12, after the fluorescent marking agent disperses within the body of the mouse 12 due to the blood circulation system and the like, the fluorescent marking agent attaches to the lesion site by an antigen-antibody reaction.

In the optical tomography measurement system 10, the mouse 12 is loaded into the optical measurement device 14 at a timing when the fluorescent marking agent administered to the mouse 12 has attached to the lesion site. The optical measurement device 14 illuminates excitation light for the fluorescent marking agent onto the mouse 12, and measures the fluorescent light intensity generated from the fluorescent marking agent within the body of the mouse 12. In the data processing device 16, the density distribution of fluorescent light (fluorescent marking agent) in the mouse 12 is computed based on the measurement data that is output from the optical measurement device 14 in accordance with the fluorescent light intensity.

As shown in FIG. 2 and FIG. 3, in the optical measurement device 14 employed in the first exemplary embodiment, the mouse 12 is placed in a sample holder 30 and loaded into the optical measurement device 14. As shown in FIG. 2, the sample holder 30 is configured from an upper mold block 32 and a lower mold block 34. The sample holder 30 forms a substantially circular column shape of a specific outer diameter, by superimposing and fitting the upper mold block 32 and the lower mold block 34 together.

A recess portion 32A is formed to the upper mold block 32 so as to match the body shape (external profile and size) of the back of the mouse 12, and a recess portion 34A is formed to the lower mold block 34 so as to match the body shape of the belly side of the mouse 12. The mouse 12 is accommodated in the sample holder 30 with the body length direction of the mouse 12 disposed along the axial direction of the sample holder 30, by covering with the upper mold block 32 when the belly side of the mouse 12 is in an accommodated state in the recess portion 34A of the lower mold block 34. The epidermis of the mouse 12 is in close contact with the inner face of the sample holder 30. In the sample holder 30, the upper mold block 32 and the lower mold block 34 are positioned to each other by, for example, a pair of engagement protrusions 36A formed to the lower mold block 34 fitting into engagement recess portions 36B formed in the upper mold block 32.

In the first exemplary embodiment, the trunk region (chest region to the lumber region) of the mouse 12 is the main measurement site, and is restrained such that at least the epidermis of the trunk region of the mouse 12 is in close contact with the inner face of the sample holder 30. The end face of the sample holder 30 at the head end of the mouse 12 configures a reference surface 38, such that when the mouse 12 has been accommodated in the sample holder 30, the position of each of organ is determined relative to the reference surface 38 according to the body shape (size).

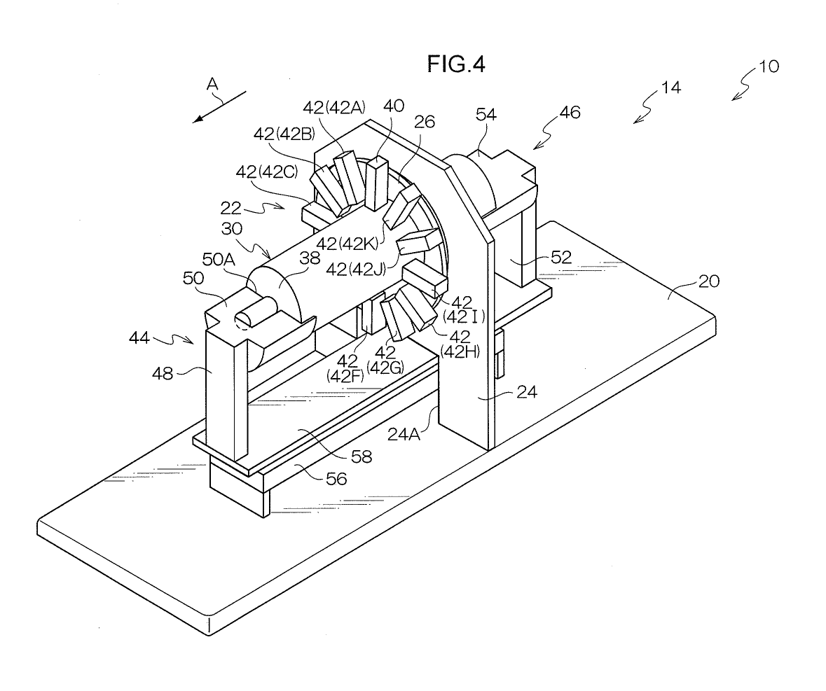

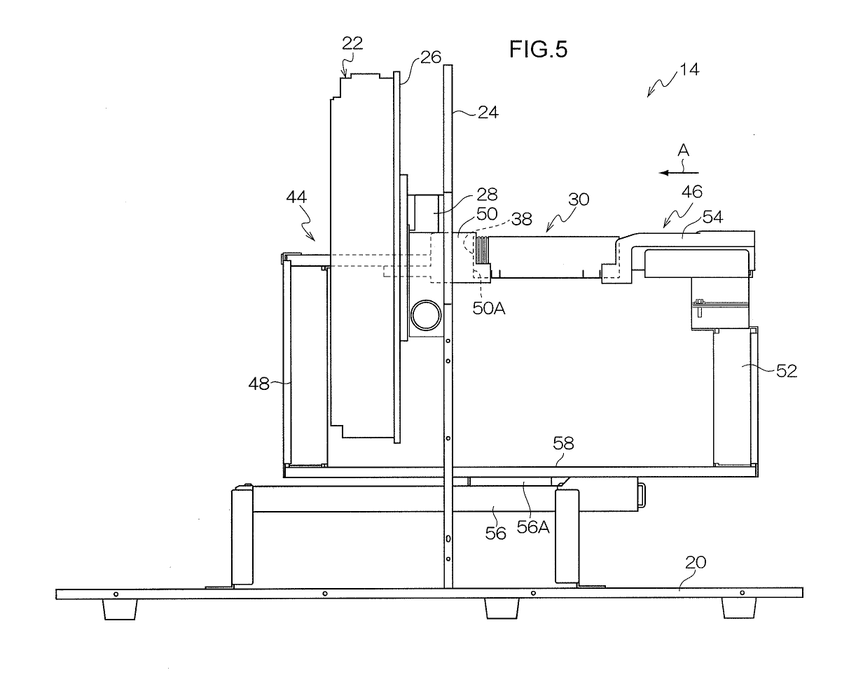

As shown in FIG. 4 and FIG. 5, a plinth 20 is disposed in the optical measurement device 14 inside a casing, not shown in the drawings, for blocking out light. A base plate 24 is disposed upright on the plinth 20. A measurement head section 22 is provided on one face of the base plate 24. As shown from FIG. 1 to FIG. 5, the measurement head section 22 is provided with a frame body 26 formed in a ring shape. The frame body 26 is disposed coaxial to a circular hole, not shown in the drawings, formed to the base plate 24.

As shown in FIG. 5, a rotary actuator 28 is attached to one face of the base plate 24, with the frame body 26 attached to the rotary actuator 28. The rotary actuator 28 is formed with a hollowed out portion, not shown in the figures, corresponding to the circular hole of the base plate 24. The rotary actuator 28 is attached to the base plate 24 such that this hollowed out portion is coaxial to the circular hole.

The rotary actuator 28 is, for example, rotationally driven by driving force from a motor, not shown in the drawings, such as, for example, a stepping motor, a pulse motor or the like. Accordingly, the frame body 26 is rotated in the optical measurement device 14 about its own axial center. Note that the rotary actuator 28 is not limited to a motor and configuration may be made so as to drive by any appropriate drive source, such air or the like.

As shown in FIG. 4 and FIG. 5, a pair of arms 44, 46 are provided in the optical measurement device 14 on either side of the base plate 24. The arm 44 has a bracket 50 attached to a leading end portion of a main pillar 48, and the leading end of the bracket 50 passes through the opening in the frame body 26 and faces towards the arm 46 side. The arm 46 has a bracket 54 attached to the leading edge portion of a main pillar 52, with the leading end of the bracket 54 passing through the opening in the 26 and facing towards the arm 44 side.

An elongated slider 56 and a sliding base 58 are disposed above the plinth 20. The slider 56 is attached above the plinth 20 so as to be disposed with its length direction along the axial direction of the frame body 26 (the left-right direction in the plane of the paper in FIG. 4 and FIG. 5), and to pass through an opening 24A (see FIG. 4) formed through a portion at the bottom end of the base plate 24. The sliding base 58 is attached to a block 56A of the slider 56 so as to be disposed with its length direction along the length direction of the slider 56. The main pillar 48 of the arm 44 is provided projecting upwards at one length direction end of the sliding base 58, and the main pillar 52 of the arm 46 is provided projecting upwards at the other end thereof.

The slider 56 is internally provided with a screw drive mechanism (not shown in the drawings) as a drive source, such as a stepping motor or the like. The block 56A moves along the length direction of the slider 56 (the left-right direction in the plane of the paper in FIG. 5) by driving with the stepping motor. Accordingly, in the optical measurement device 14 the pair of arms 44, 46 move as one along the axial direction of the frame body 26. While in this case the arms 44, 46 move, there is no limitation thereto, and configuration may be made in which it is the frame body 26 (the measurement head section 22) that moves.

In the optical measurement device 14, the sample holder 30 is mounted so as to span across between the bracket 50 of the arm 44 and the bracket 54 of the arm 46. The sample holder 30 is disposed such that the axial line of the sample holder 30 coincides with an axial center along the axial line of the frame body 26. Positioning in the sample holder 30 is by abutting the reference surface 38 against a reference face 50A set on the bracket 50.

In the optical measurement device 14, the sample holder 30 is mounted between the arms 44, 46 in a state in which the bracket 50 of the arm 44 from the pair of arms has been moved to a position at the opposite side of the base plate 24 to that of the frame body 26. In the optical measurement device 14, by driving the slider 56 the sample holder 30 is moved in the arrow A direction through the axial center portion of the frame body 26. In the optical measurement device 14, the sample holder 30 is removed from the arms 44, 46 by moving the sample holder 30 in the opposite direction to that of the arrow A direction, back to the position it was in when mounted.

As shown in FIG. 1 to FIG. 4, a light source unit 40, provided with an LED, semiconductor laser or the like as a light emitting element, is provided to the measurement head section 22 in order to emit a light beam of a specific wavelength as excitation light. Plural light receiving units 42 equipped with light reception elements are provided to the measurement head section 22 for respectively receiving fluorescent light emitted from the mouse 12.

As shown in FIG. 1, the light source unit 40 and the light receiving units 42 are disposed so as to lie in a flat plane (referred to below as the measurement plane 22A, see FIG. 3.) that is orthogonal to the axial direction of the frame body 26 such that the respective optical axes of the light receiving units 42 face towards the axial center of the frame body 26. The light source unit 40 and the light receiving units 42 are disposed in a radial shape radiating out from the axial center of the frame body 26, such that a specific angle θ is formed between adjacent respective optical axes. Note that in the first exemplary embodiment, as an example, there is a single light source unit 40, and 11 light receiving units 42A, 42B, 42C, 42D, 42E, 42F, 42G, 42H, 42I, 42J, 42K provided at angle θ intervals to each other of 30°.

In the optical measurement device 14, by disposing the sample holder 30 mounted to the arms 44, 46 at an axial central portion of the frame body 26, the beam shaped excitation light generated from the light source unit 40 is illuminated onto the peripheral face of the sample holder 30. In the optical measurement device 14, light (fluorescent light) emitted from the outer peripheral face of the sample holder 30 due to illumination of the excitation light is detected by each of the light receiving units 42.

In the optical measurement device 14, when this is being performed the measurement head section 22 (the light source unit 40 and the light receiving units 42) is rotated in the peripheral direction of the sample holder 30 by driving the rotary actuator 28, changing the illumination position of the excitation light and the reception position of the fluorescent light, and measurement of fluorescent light is performed at each of the respective positions. In the optical measurement device 14, the sample holder 30 is moved along the axial direction of the frame body 26 using the slider 56, and measurement is performed of fluorescent light at a specific position, or at specific intervals, along the axial direction of the sample holder 30.

Accordingly, in the optical measurement device 14, fluorescent light generated from the fluorescent marking agent within the body of the mouse 12 is measured at a desired position along the mouse 12 body length direction, and measurement data according to the intensity of the measured fluorescent light is obtained.

Note that in the optical measurement device 14, the wavelength of the light emitted by the light emitting element 68 is matched to a wavelength that induces fluorescent light to be generated by the fluorescent marking agent administered to the mouse 12. For example, in a case in which the fluorescent marking agent administered to the mouse 12 emits fluorescent at about 770 nm wavelength in response to illumination with excitation light of about 730 nm wavelength, in the optical measurement device 14 the optical characteristics (such as a filter band) of the light receiving units 42 are set such that light of this wavelength (about 770 nm) is received.

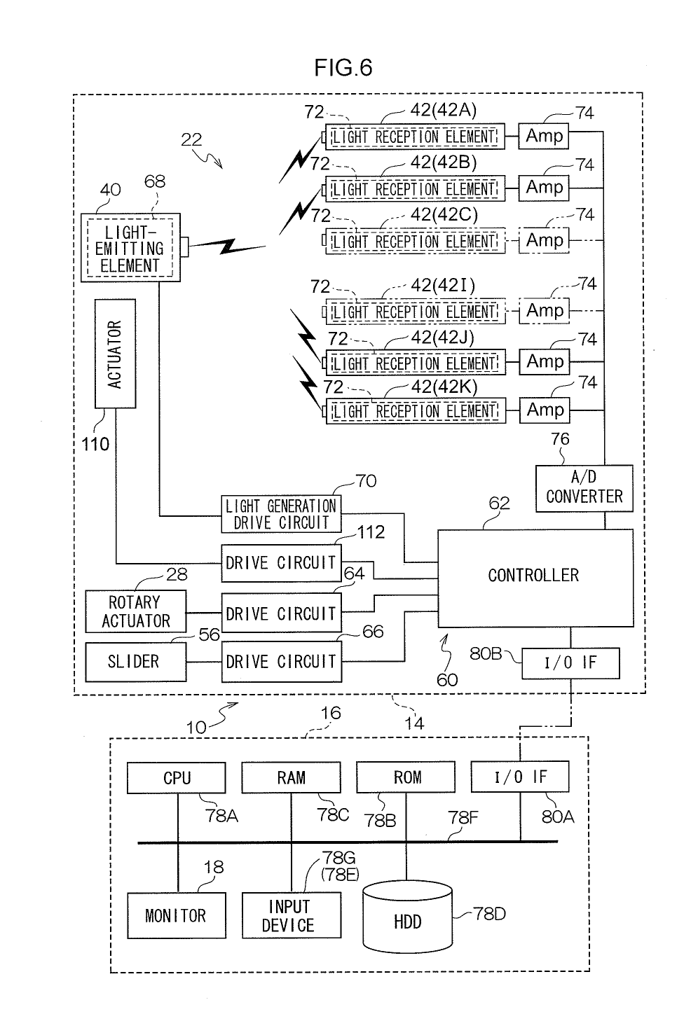

A control section 60 is provided to the optical measurement device 14, as shown in FIG. 6. A controller 62 equipped with a microcomputer, not shown in the drawings, is provided to the control section 60.

The control section 60 is provided with a drive circuit 64 for driving the motor, not shown in the drawings, of the rotary actuator 28, and a drive circuit 66 for driving the motor, not shown in the drawings, of the slider 56. The drive circuit 64 and the drive circuit 66 are connected to the controller 62. Accordingly, in the optical measurement device 14 movement of the sample holder 30 and rotation of the measurement head section 22 is controlled by the controller 62.

The light emitting element 68 is provided in the light source unit 40 for generating excitation light, and light reception elements 72 are provided in the light receiving units 42, respectively, for receiving fluorescent light. The control section 60 is equipped with a light generation drive circuit 70 that drives the light emitting element 68, amps 74 that amplify electrical signals output from the light reception elements 72, an A/D converter 76 that performs A/D conversion on the electrical signals (analogue signals) output from the amps 74.

Accordingly, measurement data detected by each of the light reception elements 72 of the light receiving units 42 is output as a digital electrical signal while the control section 60 controls light emission of the light emitting element 68 of the light source unit 40. In the optical measurement device 14, a display panel, not shown in the drawings, is provided, and, for example, the operational state of the device due to the controller 62 and the like is displayed on the display panel.

The data processing device 16 is formed with a general computer configuration, including a CPU 78A, ROM 78B, RAM 78C, a HDD 78D serving as a storage component, an input device 78G such as a keyboard 78E (see FIG. 1), mouse or the like, a monitor 18 and the like, connected together with a bus 78F.

An input-output interface (I/O IF) 80A is provided in the data processing device 16, and the I/O IF 80A is connected to an input-output interface (I/O IF) 80B provided to the control section 60 of the optical measurement device 14. Accordingly, the data processing device 16 is input with the measurement data measured by the optical measurement device 14. Note that for connection between the optical measurement device 14 and the data processing device 16 application may be made of any known standard, such as a USB interface or the like.

The data processing device 16 controls operation of the optical measurement device 14 by the CPU 78A executing a program stored on the ROM 78B or the HDD 78D, while employing the RAM 78C as a working memory, so as to measure the intensity of fluorescent light generated from the mouse 12. The data processing device 16 reads in the measurement data obtained by measurement by the optical measurement device 14 and, based on the measurement data, reconstructs a tomographic image representing the intensity distribution of fluorescent light. Note that the optical tomography measurement system 10 is not limited to a configuration in which the data processing device 16 controls operation of the optical measurement device 14, and configuration may be made in which the optical measurement device 14 operates and outputs measurement data independently.

A living organism, such as, for example, the mouse 12 or the like, acts as an anisotropic scattering medium to light. In an anisotropic scattering medium, forward scatter dominates in a region in which incident light that does not exceed a light penetration wavelength (equivalent scattering wavelength), however in a region exceeding the light penetration wavelength (equivalent scattering wavelength), multiple scattering (isotropic scatting) of light occurs with random polarity, and light scattering becomes isotropic (an isotropic scatting region). Since the region in which forward scattering dominates is narrow, or the order of a few mm, when two anisotropic scattering media are in contact with each other, one anisotropic scattering medium and the other anisotropic scattering medium can be treated as being an integrated anisotropic scattering medium.

In the first exemplary embodiment, the sample holder 30 is formed using a substance that is an anisotropic scattering medium, in order that the sample holder 30 (the upper mold block 32 and the lower mold block 34) in which the mouse 12 is accommodated can be treated as an isotropic scatting region in practice. Substances that can be employed for such a sample holder 30 include, for example, polyethylene (PE), polyacetal resin (POM) with a light isotropic scattering coefficient μs′ of 1.05 mm⁻¹, or the like. Note that the substance for forming the sample holder 30 is not limited thereto, and any substance may be appropriately used as long as it is an anisotropic scattering medium.

As long as the inside of the sample holder 30 accommodating the mouse 12 can be treated as an isotropic scattering region, scattering of light within the mouse 12 can be approximated to isotropic scattering.

When light propagating within a high density medium is subject to scattering, the intensity distribution of the light intensity can be represented by a light (photon) transport equation, which is a fundamental equation describing the flow of photon energy, and a light intensity distribution can be represented using a diffusion equation by approximating the scattering of light to isotropic scatting. A light (photon) density distribution is obtained in the data processing device 16 by computation to solve the diffusion equation employing the measurement results (measurement data) of the optical measurement device 14. Based on the computed density distribution the data processing device 16 displays an optical tomographic image (reconstructed optical tomographic image) of the mouse 12, for example on the monitor 18 or the like.

As shown in FIG. 1 to FIG. 3, in the optical measurement device 14, positioning of the mouse 12 accommodated in the sample holder 30 is performed by abutting the reference surface 38 of the sample holder 30 against the reference face 50A set in the bracket 50 of the arm 44. As shown in FIG. 3, the sample holder 30 is moved in the optical measurement device 14 along the body length direction of the mouse 12 (the axial direction of the sample holder 30) from an origin xs set based on the reference face 50A.

When this is being performed, as shown in FIG. 3, with the reference face 50A as the origin xs, measurement of fluorescent light is performed in the optical measurement device 14 every specific interval Δx (for example, Δx=3 mm) while moving from this position towards a predetermined position (a measurement position x corresponding to a predetermined location in the mouse 12).

In the optical measurement device 14, the light source unit 40 is rotated each time by a specific angle θ from a predetermined origin position (for example, to rotation positions θ₂, θ₃, . . . , θ₁₂ from an origin position θ₁) and the output signals of the light receiving units 42A to 42K are read in as measurement data D (m) at each respective rotation position θ. For light receiving units 42A to 42K, the variable m takes values m=1 to 11.

Measurement data D (x, θ, m) is thereby obtained in the optical measurement device 14. For a given value of measurement position x, the measurement data D (x, θ, m) is data within the same flat plane (measurement plane 22A) orthogonal to the movement direction of the sample holder 30. Since measurement position x is the movement position of the measurement plane 22A, it is sometimes also referred to as the movement position x.

Since the mouse 12 is an anisotropic scattering medium, excitation light propagates within the body of the mouse 12 while diffusing. Consequently, the excitation light not only excites the fluorescent marking agent in the measurement plane 22A, but also excites the fluorescent marking agent in the vicinity of the measurement plane 22A. Accordingly, each of the light receiving units 42 receives fluorescent light generated from fluorescent marking agent in the vicinity of the measurement plane 22A.

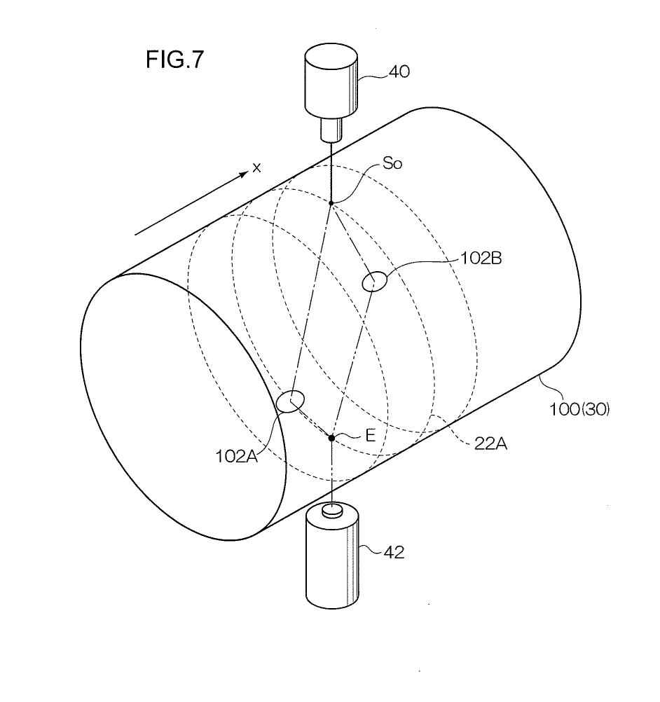

FIG. 7 shows an example of a model of an anisotropic scattering medium. This model 100 (corresponding to the sample holder 30) is formed in a substantially circular column shape in which fluorescent bodies 102 are provided representing the fluorescent marking agent (in FIG. 7, as examples, two fluorescent bodies 102A, 102B are shown). When the measurement plane 22A is between the fluorescent bodies 102A, 102B, the excitation light illuminates a spot shape on the outer peripheral face of the model 100 at this measurement plane 22A (the position of the spot is referred to as illumination position S₀ serving as a reference position).

Due to the illuminated excitation light in the model 100 propagating while scattering in the model 100, the excitation light also reaches the fluorescent bodies 102A, 102B that are separated from the measurement plane 22A. A portion of the fluorescent light generated from the fluorescent bodies 102A, 102B propagates while scattering within the model 100 and is emitted from emission position E facing the light receiving unit 42.

As a result, even though the fluorescent bodies 102A, 102B are not present in the measurement plane 22A, their fluorescent light is received by the light receiving unit 42, and corresponding measurement data D (x, θ, m) is output. Consequently, the measurement data D (x, θ, m) contains noise from fluorescent light components generated by the fluorescent bodies 102A, 102B in the vicinity of the measurement plane 22A.

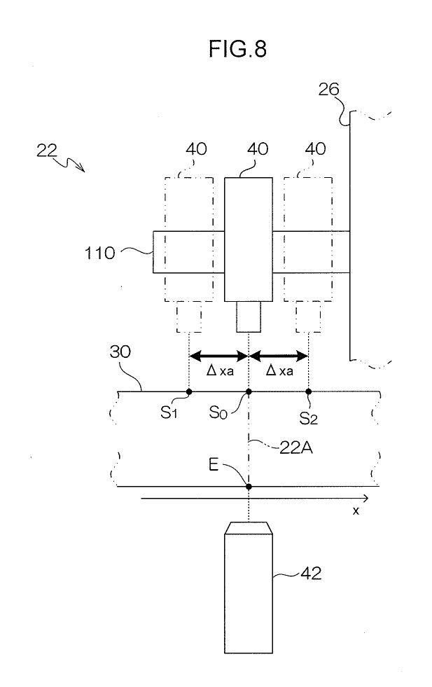

As shown in FIG. 8, the optical measurement device 14 applied to the first exemplary embodiment is equipped with an actuator 110. The actuator 110 is attached to the frame body 26 of the measurement head section 22, and the light source unit 40 is attached to the actuator 110. The actuator 110 moves the light source unit 40 along the arrow x direction relative to the frame body 26.

As shown in FIG. 6, in the control section 60, a drive circuit 112 is provided for driving a motor, not shown in the drawings, of the actuator 110, and the drive circuit 112 is connected to the controller 62. Note that any suitable drive source can be applied to the actuator 110.

As shown in FIG. 8, in the optical measurement device 14, by operating the actuator 110, the illumination position S₀ of the excitation light generated from the light source unit 40 is moved along the sample holder 30 axial direction, namely along the body length direction of the mouse 12.

In the optical measurement device 14, the light source unit 40 is moved such that the illumination position S₀ of the excitation light is in the measurement plane 22A, and fluorescent light measurement is performed with the respective light receiving units 42. In the optical measurement device 14, the light source unit 40 is moved so as to displace the illumination position S₀ of the excitation light by a specific amount Δxa towards one side or the other in the arrow x direction, and fluorescent light measurement is performed at each of the respective movement positions.

Explanation follows of a case in which, with the arrow x direction as the x axis, there is an illumination position S₁ serving as a first position in which the illumination position has been moved by specific amount Δxa to one side along the x axis relative to the illumination position on the measurement plane 22A, and an illumination position S₂ serving as a second position in which the illumination position has been moved by the specific amount Δxa in the other direction along the x axis relative to the illumination position on the measurement plane 22A. Accordingly, the illumination positions S₁, S₂ that were moved by the specific amount Δxa are symmetrically disposed on either side of the illumination position S₀, however there is no limitation thereto. Configuration may be made such that the interval between illumination positions S₀ and S₁ and the interval between illumination positions S₀ and S₂ are different from each other.

The measurement data D (x, θ, m) obtained by the optical measurement device 14 is measurement data D₀ (x, θ, m) serving as reference data of data for the illumination position S₀, measurement data D₁ (x, θ, m) serving as first data that is data for the illumination position S₁, and measurement data D₂ (x, θ, m) serving as second data that is data for the illumination position S₂. Accordingly, in the optical measurement device 14 configuration is made such that for each of the movement positions x and the rotation positions θ, measurement data D₀ (x, θ, m), D₁ (x, θ, m), D₂ (x, θ, m) is obtained for each of the respective light receiving units 42.

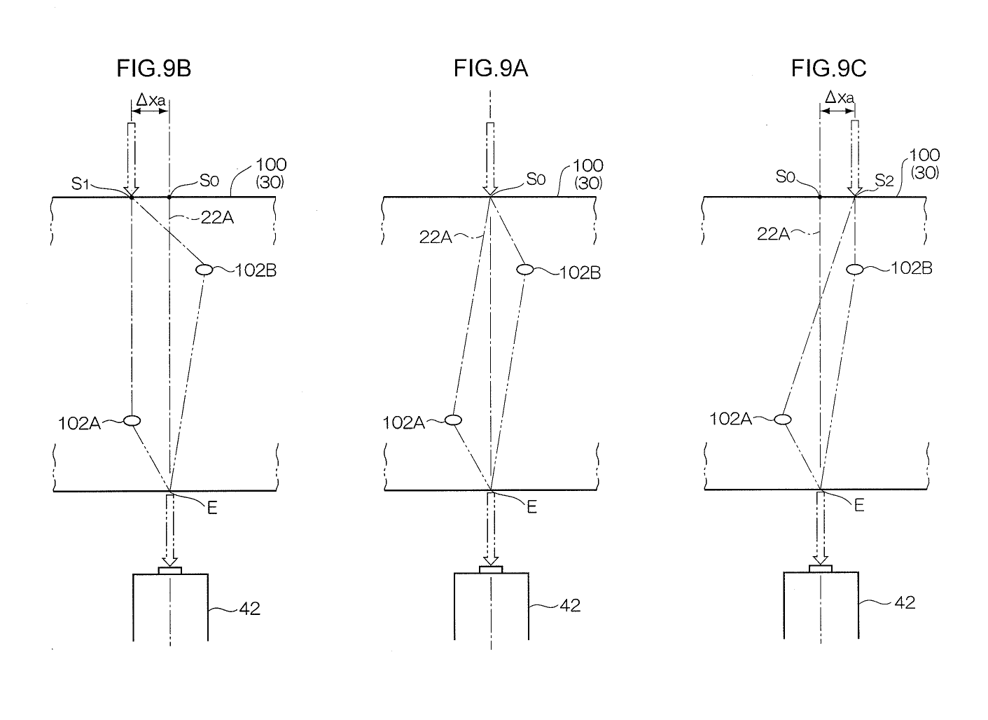

As shown in FIG. 9A, when excitation light is illuminated onto the illumination position S₀ in the measurement plane 22A, the excitation light in the model 100 is scattered and the fluorescent bodies 102A, 102B are excited. The fluorescent light generated by the fluorescent bodies 102A, 102B scatters and measurement data D₀ (x, θ, m) is obtained by the light receiving unit 42 receiving the fluorescent light emitted from the emission position E.

As shown in FIG. 9B, when excitation light is illuminated onto the illumination position S₁, the fluorescent light caused thereby to be generated from the excited fluorescent bodies 102A, 102B is received by the light receiving unit 42, and the measurement data D₁ (x, θ, m) is obtained.

The propagation separation distance of the excitation light from the illumination position S₁ to the fluorescent body 102A is shorter than the propagation separation distance of the excitation light from the illumination position S₀ to the fluorescent body 102A shown in FIG. 9A. Accordingly, the fluorescent light component generated from the fluorescent body 102A included in the measurement data D₁ (x, θ, m) is comparatively greater than in the measurement data D₀ (x, θ, m).

Furthermore, as shown in FIG. 9C, when excitation light is illuminated onto the illumination position S₂, measurement data D₂ (x, θ, m) is obtained by the light receiving unit 42 receiving fluorescent light caused to be generated from the fluorescent bodies 102A, 102B.

The propagation separation distance of the excitation light from the illumination position S₂ to the fluorescent body 102B is shorter than the propagation separation distance of the excitation light from the illumination position S₀ to the fluorescent body 102B shown in FIG. 9A. Accordingly, the fluorescent light component generated from the fluorescent body 102B included in the measurement data D₂ (x, θ, m) is comparatively greater than in the measurement data D₀ (x, θ, m).

The optical measurement device 14 changes the illumination position when the mouse 12 is the measurement subject, acquires the measurement data D₀ (x, θ, m), D₁ (x, θ, m), D₂ (x, θ, m), and outputs this data to the data processing device 16.

The data processing device 16 employs the measurement data D₀ (x, θ, m), D₁ (x, θ, m), D_{Z} (x, θ, m) to derive measurement data (referred to below as measurement data D′ (x, θ, m) from which fluorescent light components from the fluorescent bodies 102 adjacent to the measurement plane 22A have been removed (corrects the measurement data). The data processing device 16 performs reconstruction of a density distribution of fluorescent light using the measurement data D′ (x, θ, m).

The measurement data D′ (x, θ, m) can, for example, be derived using the following computation (Equation (1)) from the measurement data D₀ (x, θ, m), D₁ (x, θ, m), D₂ (x, θ, m) obtained by illuminating excitation light on the illumination position S₀ and the illumination positions S₁, S₂ that are symmetrically disposed on either side of the illumination position S₀.

D′(x,θ,m)=2D(x,θ,m)−k{D₁(x,θ,m)+D₂(x,θ,m)} (1)

wherein k is a correction coefficient and measurement data from which the noise fluorescent light components have been removed is obtained by pre-setting this correction coefficient k at an appropriate value.

The data processing device 16 performs tomographic image reconstruction based on the corrected measurement data D′ (x, θ, m). In the first exemplary embodiment, explanation has been given of a case in which the correction of measurement data is performed in the data processing device 16, however there is no limitation thereto, and configuration may be made in which correction is performed in the control section 60 of the optical measurement device 14.

In the first exemplary embodiment, an absorption coefficient μa and an reduced scattering coefficient μs′ are set as optical characteristic values for the fluorescent light generated by the fluorescent marking agent internally administered to the mouse, and these values stored in the data processing device 16. The data processing device 16 computes a fluorescent light intensity, based on the pre-set optical characteristic values and the measurement data D′ (x, θ, m), by employing calculation of a forward problem using a light diffusion equation. The data processing device 16 evaluates a difference between the computed fluorescent light intensity and the fluorescent light intensity obtained from measurement data D′ (x, θ, m).

Furthermore, the data processing device 16 calculates an inverse problem of the light diffusion equation. Then, the absorption coefficient based on the density distribution of fluorescent bodies is revised based on the fluorescent light intensity that reduces the difference obtained in the above evaluation result and the fluorescent light intensity is calculated by using the optical characteristic values based on the revised density distribution of fluorescent marking agent.

The data processing device 16, by performing repetitions of revising the fluorescent light intensity and evaluation, for example, generates a fluorescent light density distribution (intensity distribution), this being optical tomographic data, from the optical characteristic values based on the density distribution of fluorescent marking agent when evaluation is made that the computed fluorescent light intensity matches the measurement data. The data processing device 16 then reconstructs an optical tomographic image based on this optical tomographic data. Note that reconstruction of an optical tomographic image can be made by application of any suitable configuration that employs a computation result based on measurement of fluorescent light intensity of the fluorescent marking agent and a light transport equation or light diffusion equation based on the measurement data D′ (x, θ, m) obtained from the measurement.

Explanation follows regarding processing in the optical tomography measurement system 10 according to the first exemplary embodiment.

In the data processing device 16 of the optical tomography measurement system 10 according to the first exemplary embodiment, the correction coefficient k for use in correcting measurement data is pre-set, and the measurement data D₀ (x, θ, m) is corrected based on the correction coefficient k and the measurement data D₁ (x, θ, m), D₂ (x, θ, m), thereby acquiring measurement data D′ (x, θ, m). The data processing device 16 employs the corrected measurement data D′ (x, θ, m) to perform tomographic image reconstruction. Explanation first follows regarding an example of setting the correction coefficient k.

Setting Correction Coefficient k

Setting of the correction coefficient k is performed by simulation employing a simulation model 100A of the mouse 12 and a similar anisotropic scattering medium.

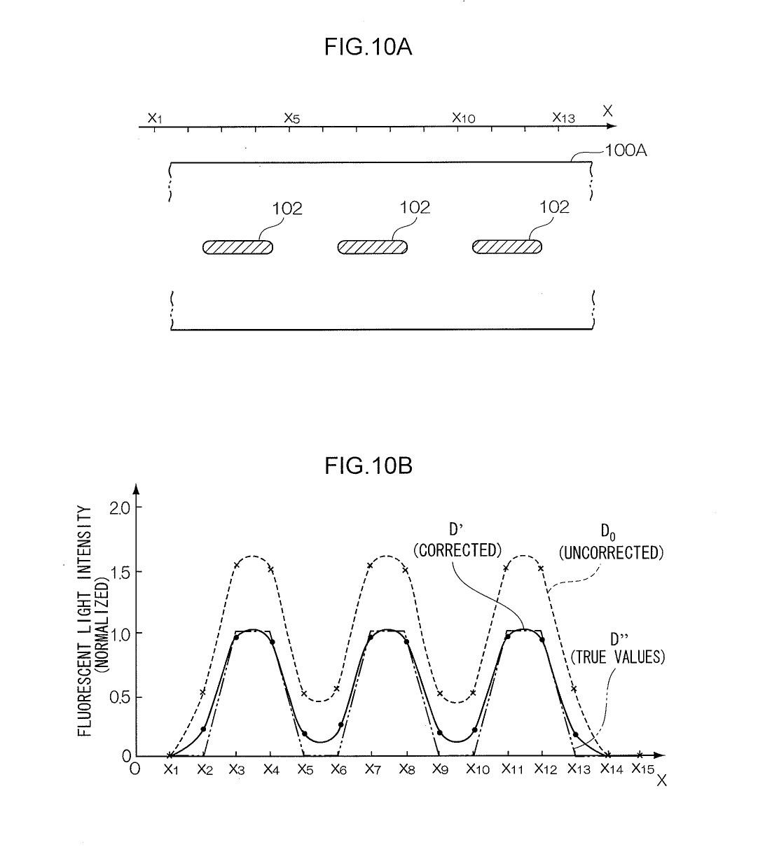

As shown in FIG. 10A, in the simulation model 100A the fluorescent bodies 102 (102A, 102B) are provided at predetermined positions. The simulation model 100A has the reduced scattering coefficient μs′=1.0 mm⁻¹ and the absorption coefficient μa=0.05 mm⁻¹, with the size of the fluorescent bodies 102A, 102B and the separation between the fluorescent bodies 102A, 102B set at twice the cross-section interval of the simulation model 100A.

In the simulation model 100A, the irradiation position of the excitation light is changed to illumination positions S₀, S₁, S₂, and the measurement data D₀ (x, θ, m), D₁ (x, θ, m), D₂ (x, θ, m) derived by computation for the illumination positions S₀, S₁, S₂.

When this is being performed, measurement data D″ (x, θ, m) (true values) for a case where there is no influence from fluorescent light components generated by the fluorescent bodies 102A, 102B and measurement data D₀ (x, θ, m) (uncorrected values) including fluorescent light components generated from the fluorescent bodies 102A, 102B are computed.

FIG. 10B shows the computation result for the simulation model 100A. Note that in FIG. 10B, D′ (x, θ, m) is shown by the solid line, D₀ (x, θ, m) is shown by the dashed line, and normalization is performed based on the maximum value of the D′ (x, θ, m).

When correction is performed on the measurement data D₀ (x, θ, m) using the above Equation (1), the correction coefficient k given by the following Equation (2) is employed.

k={2D₀(xₙ,θₚ,m)−D″(xₙ,θₚ,m)}/{D₁(xₙ,θₚ,m)+D₂(xₙ,θₚ,m)} (2)

Note that n and p are variables, with n adopting a given movement distance from 1 to 15 in the x direction, and p adopting given a rotation angle from 1 to 12.

When the corrected measurement data is taken as the measurement data D′ (x, θ, m), the required correction coefficient k is one to make measurement data D₀ (x, θ, m) approximate to the measurement data D″ (x, θ, m). For example, a value of correction coefficient k is set such that at least one of the measurement data D₀ (x, θ, m) is overlapped with the measurement data D″ (x, θ, m).

Preferably {D₁ (xₙ, θₚ, m)+D₂ (xₙ, θₚ, m)} is large in order to make the error in correction coefficient k as small as possible.

Setting is such that D₁ (xₙ, θₚ, m)+D₂ (xₙ, θₚ, m)=max {D₂ (xₙ, θₚ, m)+D₂ (xₙ, θₚ, m)}. Namely, measurement data is made such that {D₁ (xₙ, θₚ, m)+D₂ (xₙ, θₚ, m)} is the maximum value from out of all measurement data D₀ (xₙ, θₚ, m) (movement positions x (15)×rotation positions θ (12)×light receiving units 42 (11)=1980 elements). Accordingly, measurement data D₀ (x, θ, m), D₁ (x, θ, m), D₂ (x, θ, m) is employed for the identified (xₙ, θₚ, m).

Measurement data D′ (x, θ, m) from correcting the measurement data D₀(xₙ, θₙ, m) based on the correction coefficient k thus computed is shown in FIG. 10B by double-dot broken lines, and D′ (x, θ, m) approximating to D″ (x, θ, m) is obtained. The data processing device 16 stores the correction coefficient k for each of the light receiving units 42. Note that the Equation (2) for deriving the correction coefficient k is only an example thereof, and there is no limitation thereto.

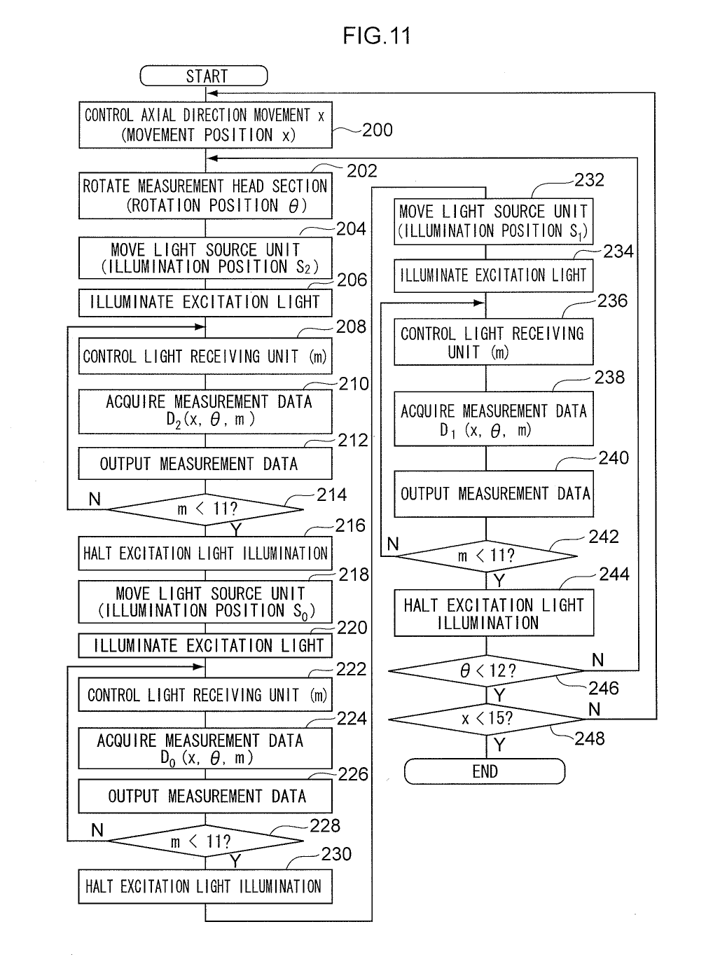

FIG. 11 shows an example of a process for measuring fluorescent light in the optical measurement device 14 according to the first exemplary embodiment. The optical measurement device 14 acquires the measurement data D₀ (x, θ, m), the measurement data D₁ (x, θ, m) and the measurement data D₂ (x, θ, m).

In the flow chart, start is by way of mounting the sample holder 30 accommodating the mouse 12, and at step 200, the sample holder 30 is moved such that the measurement plane 22A is placed at one of specific movement positions x (sequential measurement at movement positions x₁ to x₁₅ of FIG. 3, with the initial movement position x₁) of the mouse 12. Next, at step 202, the frame body 26 of the measurement head section 22 is disposed at one of pre-set rotation positions θ (sequential measurement at the rotation positions θ₁ to θ₁₂, with the initial rotation position θ₁). Then, at step 204, the actuator 110 is actuated and the light source unit 40 is moved so as to illuminate excitation light onto illumination position S₂.

At the next step 206, the light source unit 40 is operated and excitation light is illuminated towards the sample holder 30. Then, at step 208, control is performed such that fluorescent light emitted from the sample holder 30 due to the excitation light is received in sequence by the light receiving units 42 (sequential measurements at m₁ to m₁₁, with the initial m₁).

Accordingly, at step 210, measurement data D₂ (x, θ, m) is acquired according to the amount of light received by the controlled light receiving unit 42, and the measurement data D₂ (x, θ, m) is output to the data processing device 16 at step 212.

Next, at step 214, determination is made as to whether or not measurement data D₂ (x, θ, m) has been output from all of the light receiving units 42, and determination at step 214 is negative if there is a light receiving unit 42 remaining from which no output has been made (m<11), processing returns to step 208, and the measurement data D₂ (x, θ, m) is acquired with the next light receiving unit 42, and the acquired data output.

Determination at step 214 is positive when the measurement data D₂ (x, θ, m) has been output for all of the light receiving units 42, processing proceeds to step 216, and operation of the light source unit 40 is temporarily halted.

At the next step 218, the actuator 110 is actuated to move the light source unit 40 such that excitation light is illuminated to the illumination position S₀.

At the next steps 220, 222, the light source unit 40 is operated and excitation light is illuminated towards the sample holder 30, and control is performed such that fluorescent light emitted from the sample holder 30 due to the excitation light is received in sequence by the light receiving units 42 (sequential measurement at m₁ to m₁₁, with the initial m₁).

Accordingly, in steps 224 and 226, the measurement data D₀ (x, θ, m) corresponding to the amount of light received by the controlled light receiving unit 42 is acquired, and the acquired measurement data D₀ (x, θ, m) is output to the data processing device 16.

At the next step 228, determination is made as to whether or not measurement data D₀ (x, θ, m) has been output for all of the light receiving units 42. Negative determination is made at step 228 when there is a light receiving unit 42 from which output has not yet been made (m<11), and processing returns to step 222 where measurement data D₀ (x, θ, m) for the next light receiving unit 42 is acquired and output.

Positive determination is made at step 228 when the measurement data D₀ (x, θ, m) has been output for all of the light receiving units 42, processing proceeds to step 230, and operation of the light source unit 40 is temporarily halted.

At the next step 232, the actuator 110 is actuated to move the light source unit 40 such that excitation light is illuminated onto the illumination position S₁.

At the next steps 234, 236 the light source unit 40 is operated and excitation light is illuminated towards the sample holder 30, and control is performed such that fluorescent light emitted from the sample holder 30 due to the excitation light is received in sequence by the light receiving units 42 (sequential measurement at m₁ to m₁₁, with the initial m₁).

Accordingly, in steps 238, 240 measurement data D₁ (x, θ, m) corresponding to the amount of light received by the controlled light receiving unit 42 is acquired, and the acquired measurement data D₁ (x, θ, m) is output to the data processing device 16.

At the next step 242, determination is made as to whether or not measurement data D₁ (x, θ, m) has been output for all of the light receiving units 42. Negative determination is made at step 242 when there is a light receiving unit 42 from which output has not yet been made (m<11), and processing returns to step 236 where measurement data D₁ (x, θ, m) for the next light receiving unit 42 is acquired and output.

Positive determination is made at step 242 when the measurement data D₁ (x, θ, m) has been output from all of the light receiving units 42, processing proceeds to step 244, and operation of the light source unit 40 is temporarily halted.

In this manner, when the measurement data D₀ (x, θ, m), D₁ (x, θ, m), D₂ (x, θ, m) has been measured and output for each of the light receiving units 42 at the movement position x and rotation position θ, determination is made as to whether or not measurement has been completed for all rotation positions θ(θ₁ to θ₁₂). Negative determination is made at step 246 when not all rotation positions have been completed (θ<12), and processing returns to step 202 and measurement of the next rotation position θ is started. Positive determination is made at step 246 when measurement has been completed for all the rotation positions θ and processing proceeds to step 248.

At step 248, determination is made as to whether or not measurement of all of the movement positions x (x₁ to x₁₅) have been completed. Negative determination is made at step 248 when not all have been completed (x<15) where processing returns to step 200 and measurement at the next movement position x is started.

Positive determination is made at step 248 when measurement has been completed for all of the movement positions x (x₁ to x₁₅) and measurement processing is ended. When all the measurement processing has been completed, the optical measurement device 14 operates the slider 56 and returns the sample holder 30 to the mounting position.

Accordingly, in the optical measurement device 14, measurement data D₀ (x, θ, m), D₁ (x, θ, m), D₂ (x, θ, m) from each of the light receiving units 42 for all the movement positions x₁ to x₁₅ and for all the rotation positions θ₁ to θ₁₂ is output to the data processing device 16.

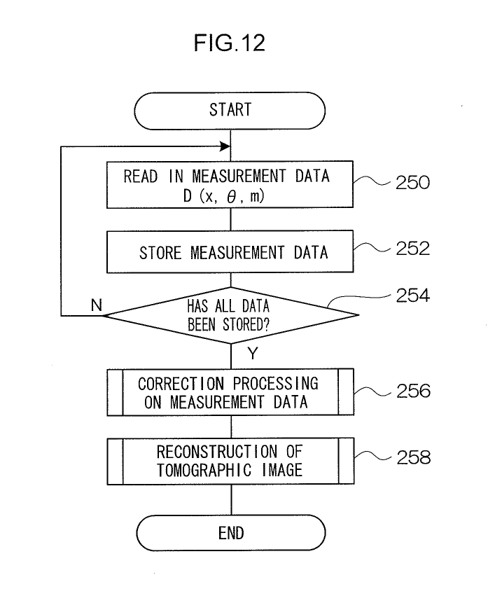

FIG. 12 schematically shows reconstruction processing of fluorescent light density distribution in the data processing device 16, based on the measurement data D₀ (x, θ, m), D₁ (x, θ, m), D₂ (x, θ, m) output from the optical measurement device 14.

This flow chart is, for example, executed in parallel to the measurement processing in the optical measurement device 14, in the first step 250 the measurement data D₀ (x, θ, m), D₁ (x, θ, m), D₂ (x, θ, m) output from the optical measurement device 14 is read in. At step 252 the read-in measurement data D₀ (x, θ, m), D₁ (x, θ, m), D₂ (x, θ, m) is stored in a memory, such as, for example the HDD 78D.

At step 254, determination is made as to whether or not measurement data D₀ (x, θ, m), D₁ (x, θ, m), D₂ (x, θ, m) for all the measurement positions x and all the rotation positions θ have been stored, and reading in and storage of the measurement data D₀ (x, θ, m), D₁ (x, θ, m), D₂ (x, θ, m) is ended on positive determination.

At the next step 256, the Equation (1) is employed to perform correction processing on the measurement data D₀ (x, θ, m), D₁ (x, θ, m), D_{Z} (x, θ, m) to acquire the measurement data D′ (xₙ, θₚ, m). Then step 256 is executed at a specific timing (at instruction of reconstruction processing).

At step 256, correction processing of the measurement data D₀ (x, θ, m) is performed based on the stored measurement data D₀ (x, θ, m), D₁ (x, θ, m), D₂ (x, θ, m) and the pre-set correction coefficient k, and the corrected measurement data D′ (x, θ, m) is thereby acquired. Equation (1) is employed for this processing.

The measurement data D′ (x, θ, m) is obtained as the measurement data D₀ (x, θ, m) from which the noise fluorescent light components have been removed. Then, processing proceeds to step 258, and the data processing device 16 performs reconstruction processing of the fluorescent light density distribution based on the corrected D′ (x, θ, m).

At the next step 258, reconstruction processing of a tomographic image of the mouse 12 is performed utilizing the corrected measurement data D′ (xₙ, θₚ, m). An appropriate known method may be applied for such reconstruction processing.

High precision reconstruction processing of the density distribution can thereby be performed in the optical tomography measurement system 10 by removing noise arrising from fluorescent light components generated by fluorescent marking agent other than on the measurement plane 22A.

### Second Exemplary Embodiment

Explanation now follows regarding a second exemplary embodiment. The basic configuration of the second exemplary embodiment is similar to that of the first exemplary embodiment, and similar configurations in the second exemplary embodiment to that of the first exemplary embodiment are allocated the same reference numeral and further explanation is omitted. The second exemplary embodiment employs a light source unit 40A as a reference light source, a light source unit 40B as a first light source, and a light source unit 40C as a second light source, in place of the light source unit 40 of the first exemplary embodiment.

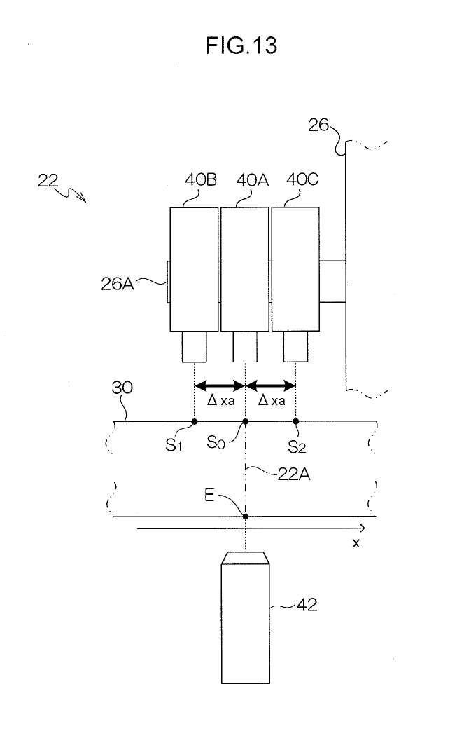

As shown in FIG. 13, a support shaft 26A is provided to one face of the frame body 26. The support shaft 26A protrudes out in the x axis direction from the frame body 26, and the light source units 40A, 40B, 40C are attached to the support shaft 26A, with the light source unit 40A is attached between the other two. The light source unit 40A illuminates excitation light onto the illumination position S₀ on the peripheral face of the sample holder 30, the light source unit 40B onto the illumination position S₁, and the light source unit 40C onto the illumination position S₂.

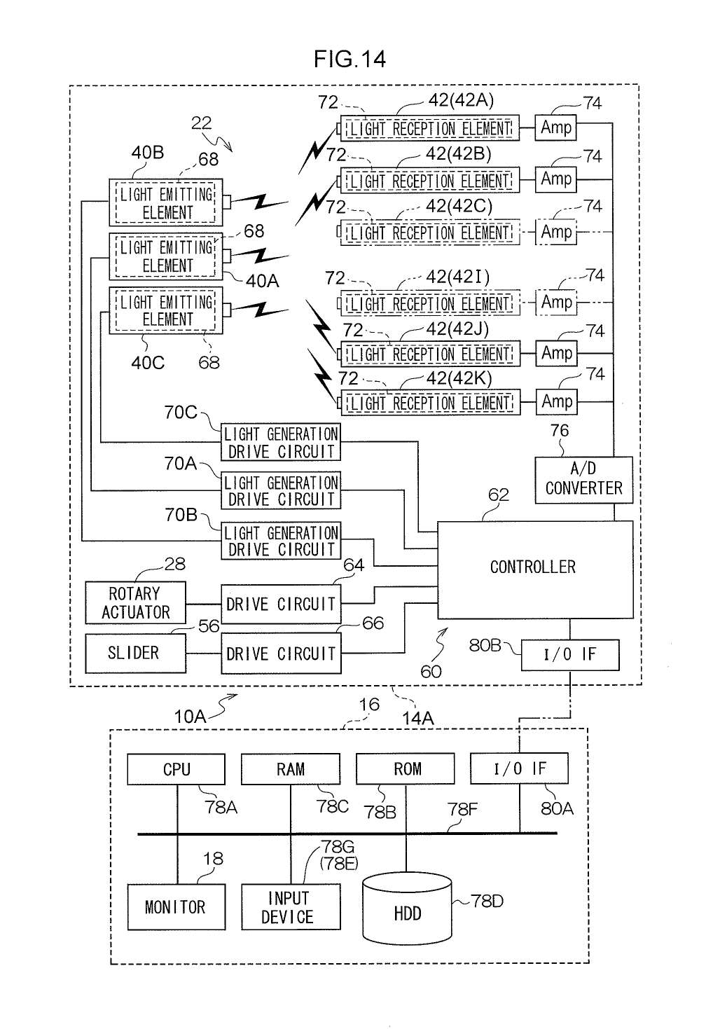

As shown in FIG. 14, light emitting elements 68 are provided in the light source units 40A, 40B, 40C, and the control section 60 is equipped with a light generation drive circuit 70A for driving the light emitting element 68 of the light source unit 40A, a light generation drive circuit 70B for driving the light emitting element 68 of the light source unit 40B, and a light generation drive circuit 70C for driving the light emitting element 68 of the light source unit 40C. The light generation drive circuits 70A, 70B, 70C are connected to a controller 62. In an optical measurement device 14A, light generation from the light source units 40A, 40B, 40C is thereby controlled by the controller 62.

Namely, in the optical measurement device 14A, configuration is made such that the light source units 40A, 40B, 40C are provided corresponding to the respective illumination positions S₀, S₁, S₂. While in the second exemplary embodiment individual light source units 40A, 40B, 40C are provided corresponding to the illumination positions S₀, S₁, S₂, there is no limitation thereto, and a single light source provided with plural respective light emitting elements 68 may be employed to illuminate excitation light to the illumination positions S₀, S₁, S₂, respectively. In the second exemplary embodiment, by employing the light source units 40A, 40B, 40C the illumination position of the excitation light is thereby changed and fluorescent light measurement is performed.

Explanation follows regarding operation of the optical measurement device 14A according to the second exemplary embodiment.

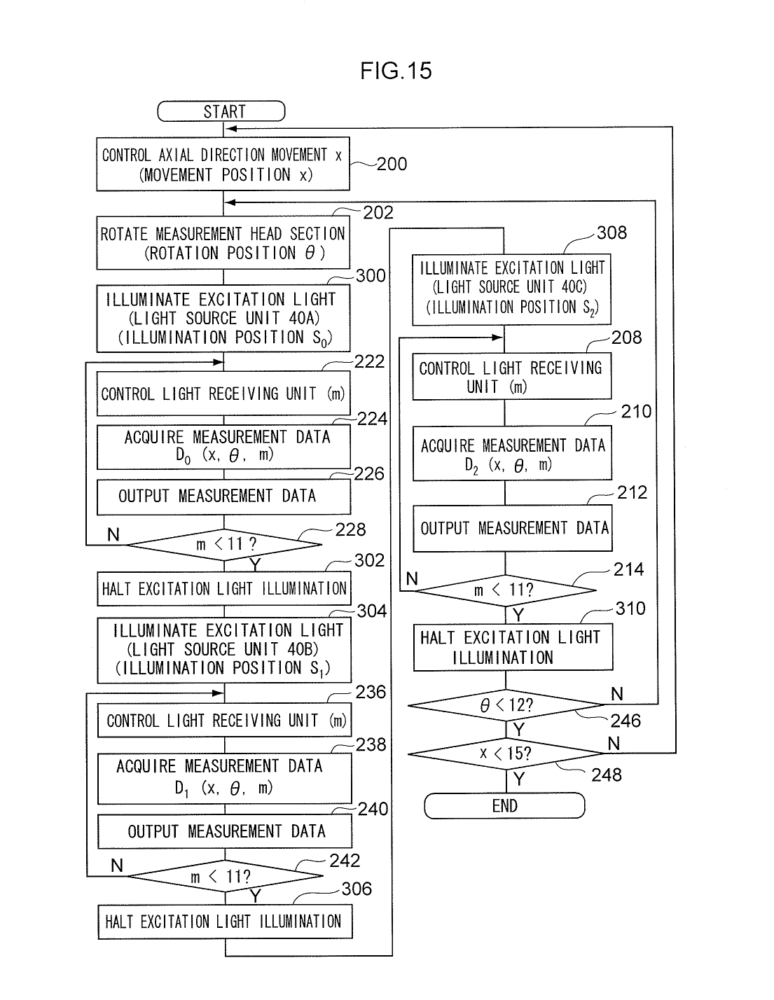

FIG. 15 shows an example of measurement processing of fluorescent light in the optical measurement device 14A according to the second exemplary embodiment. Note that in the flow chart of FIG. 15 steps that are similar to the fluorescent light measurement processing in the first exemplary embodiment (FIG. 11) are allocated the same reference numerals, and further explanation thereof is omitted.

In the flow chart of FIG. 15, start is by way of mounting the sample holder 30 accommodating the mouse 12, and at step 200, by operation of the slider 56 the sample holder 30 is moved such that the measurement plane 22A is placed at one of specific movement positions x (for sequential measurement at movement positions x₁ to x₁₅ of FIG. 3, with the initial movement position x₁) of the mouse 12. Next, at step 202, the frame body 26 of the measurement head section 22 is disposed at one of pre-set rotation positions θ (for sequential measurement at the rotation positions θ₁ to θ₁₂, with the initial rotation position θ₁).

At step 300, the light source unit 40A is operated and excitation light is illuminated towards the sample holder 30 such that excitation light is illuminated onto the illumination position S₀.

At the next steps 222, 224, 226 control is performed such that fluorescent light emitted from the sample holder 30 due to the excitation light is received in sequence by the light receiving units 42 (sequential measurement at m₁ to m₁₁, with the initial m₁), and measurement data D₀ (x, θ, m) corresponding to the amount of light received by the controlled light receiving unit 42 is acquired, and the acquired measurement data D₀ (x, θ, m) is output to the data processing device 16.

At the next step 228, determination is made as to whether or not measurement data D₀ (x, θ, m) has been output for all of the light receiving units 42. Negative determination is made at step 228 when there is a light receiving unit 42 from which there has not yet been output (m<11), and processing returns to step 222 where measurement data D₀ (x, θ, m) for the next light receiving unit 42 is acquired and output. Positive determination is made at step 228 when the measurement data D₀ (x, θ, m) has been output from all of the light receiving units 42, processing proceeds to step 302, and operation of the light source unit 40A is halted.

At the next step 304, the light source unit 40B is operated and excitation light is illuminated towards the sample holder 30 such that excitation light is illuminated onto the illumination position S₁.

Then the next steps 236, 238, 240, 242 are repeated and positive determination is made at step 242 when measurement data D₁ (x, θ, m) has been output from all of the light receiving units 42, processing proceeds to step 306, and operation of the light source unit 40B is halted.

At the next step 308, the light source unit 40C is operated and excitation light is illuminated towards the sample holder 30 such that excitation light is illuminated onto the illumination position S₂.

Then the next steps 208, 210, 212, 214 are repeated and positive determination is made at step 214 when measurement data D₂ (x, θ, m) has been output from all of the light receiving units 42, processing proceeds to step 310, and operation of the light source unit 40C is halted.

In this manner, when the measurement data D₀ (x, θ, m), D₁ (x, θ, m), D₂ (x, θ, m) has been measured and output for each of the light receiving units 42 at the movement position x and rotation position θ, determination is made as to whether or not measurement has been completed for all rotation positions θ (θ₁ to θ₁₂). Negative determination is made at step 246 when not all rotation positions have been completed (θ<12), processing returns to step 202 and measurement of the next rotation position θ is started. Positive determination is made at step 246 when measurement has been completed for all the rotation positions θ and processing proceeds to step 248.

At step 248, determination is made as to whether or not measurement of all of the movement positions x (x₁ to x₁₅) has been completed. Negative determination is made at step 248 when not all movement positions have been completed (x<15), processing returns to step 200, and measurement at the next movement position x is started.

Positive determination is made at step 248 when measurement has been completed for all of the movement positions x (x₁ to x₁₅) and the measurement processing is ended. When all the measurement processing has been completed, the optical measurement device 14 operates the slider 56 and returns the sample holder 30 to the mounting position.

Another Embodiment of Light Source Unit

Note that while the actuator 110 is employed in the first exemplary embodiment to move the light source unit 40 parallel to the x axis in order to change the illumination position of the excitation light to the illumination positions S₀, S₁, S₂, and the three light source units 40A, 40B, 40C are provided in the second exemplary embodiment to accomplish the same, the configuration for changing the illumination position of the excitation light is not limited thereto.

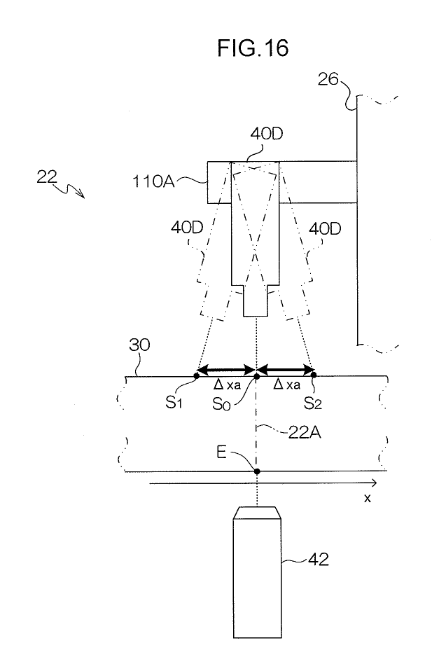

For example, as shown in the example in FIG. 16, configuration may be made with application of a light source unit 40 that, for example, swings, such that the optical axis is inclined depending on the illumination position. An actuator 110A is attached to one face of the frame body 26 in place of the actuator 110 in the first exemplary embodiment. A light source unit 40D is supported by the actuator 110A. The actuator 110A swings the light source unit 40D such that the optical axis of excitation light generated by the light source unit 40D moves in the arrow x direction. This thus enables the illumination position of excitation light generated from the light source unit 40D to be changed to the illumination positions S₀, S₁, S₂.

Even when thus configured, the measurement data D₀ (x, θ, m), D₁ (x, θ, m), D₂ (x, θ, m) can be obtained, and reconstruction of the fluorescent light density distribution can be performed based on the measurement data D₀ (x, θ, m), D₁ (x, θ, m), D₂ (x, θ, m).

Note that the present exemplary embodiments explained above do not limit the configuration of the present invention.

For example, since the forward scatting region of the mouse 12 (the sample holder 30) is narrow, no particular problems occur even if the excitation light is not illuminated perpendicularly onto each of the illumination positions of the excitation light.

Note that since the light within the living organism scatters 3-dimensionally, there is a time-resolved measurement method as a method to resolve problems of reduced reliability of reconstruction precision caused by cross-talk with fluorescent bodies distributed in adjacent cross-sections. In such a method, a light pulse with a narrow time band width is made incident on a light scattering medium, measurement is made of way the light pulse waveform that has propagated through the substance spreads out with time, and a propagation distance is obtained from this time profile. Namely, while the fluorescent light components from adjacent cross-sections can be estimated, such a time-resolved measurement method requires high time resolution ability, and since an extremely short light is used, such a method is disadvantageous from the perspectives of sensitivity and signal/noise ratio. Such a method does not resolve issues of simplification and lowering cost.

In contrast thereto, the optical tomography measurement system 10 can reduce processing load and reduce cost, while reducing any fall in image precision during reconstruction.

What is claimed is:

1. An optical tomography measurement device comprising:
an illumination component that illuminates excitation light onto a measurement subject from a light source disposed such that its optical axis is orthogonal to the body length direction of a living organism that is the measurement subject;
a light reception component that is disposed such that its optical axis is in a measurement plane that is orthogonal to the body length direction of the measurement subject, and that receives fluorescent light generated from a fluorescent marking agent inside the measurement subject in response to the excitation light and emitted from a surface of the measurement subject;
a change component that changes an illumination position of the excitation light onto the measurement subject by the illumination component to a reference position in the measurement plane and a first position and a second position disposed along the body length direction on either side of the reference position;
an acquisition component that acquires reference data corresponding to the amount of fluorescent light received by the light reception component when the excitation light is illuminated onto the reference position, first data corresponding to the amount of fluorescent light received by the light reception component when the excitation light is illuminated onto the first illumination position, and second data corresponding to the amount of fluorescent light received by the light reception component when the excitation light is illuminated on the second illumination position; and
a correction component that corrects the reference data so as to remove fluorescent light components emitted from the fluorescent marking agent outside of the measurement plane based on the first data and the second data.

2. The optical tomography measurement device of claim 1, wherein the change component changes the illumination position of the excitation light such that the first illumination position and the second illumination position are symmetrically disposed on either side of the measurement plane.

3. The optical tomography measurement device of claim 1, wherein:
the illumination component includes a reference light source that illuminates the excitation light onto the reference position, a first light source that illuminates the excitation light onto the first illumination position, and a second light source that illuminates the excitation light onto the second illumination position; and
the change components selectively operates the reference light source, the first light source or the second light source.

4. The optical tomography measurement device of claim 1, further comprising a movement component that moves the light source in the body length direction of the measurement subject, wherein the change component illuminates the excitation light onto the reference position, the first illumination position, or the second illumination position by moving the light source with the movement component.

5. The optical tomography measurement device of claim 1, further comprising a swing component that swings the optical axis of the excitation light generated from the light source, wherein the change component directs the optical axis of the excitation light to the reference position, the first illumination position, or the second illumination position using the swing component.

6. The optical tomography measurement device of claim 1, further comprising a reconstruction component that, with the reference data corrected by the correction component as measurement data from the light reception component, reconstructs a fluorescent light density distribution within the measurement subject based on the measurement data.

7. The optical tomography measurement device of claim 1, further comprising a measurement position moving component that moves the measurement plane by moving the illumination component and the light reception component as one along the body length direction of the measurement subject.
